(19) United States
(12) Patent Application Publication
(10) Pub. No.: US 2018/0320769 A1
(43) Pub. Date: Nov. 8, 2018

(54) BEARING ARRANGEMENT FOR A STEPPED PLANETARY GEAR, AND EPICYCLIC GEARING EQUIPPED THEREWITH FOR A MOTOR VEHICLE DRIVE UNIT

(71) Applicant: Schaeffler Technologies AG & Co. KG, Herzogenaurach (DE)

(72) Inventor: Franz Kurth, Nurnberg (DE)

(73) Assignee: Schaeffler Technologies AG & Co. KG, Herzogenaurach (DE)

(21) Appl. No.: 15/773,314

(22) PCT Filed: Nov. 23, 2016
(86) PCT No.: PCT/DE2016/200537

§ 371 Date: May 3, 2018

(30) Foreign Application Priority Data
Dec. 1, 2015 (DE) 10 2015 223 915.2

(51) Int. Cl. F16H 48/11; F16H 48/38; F16H 57/08; F16C 19/38

(52) U.S. Cl. CPC F16H 48/11; F16H 48/38; F16C 2361/61; F16C 19/38; F16H 2057/085; F16H 57/08

(57) ABSTRACT

The invention relates to a bearing arrangement for supporting a stepped planetary gear in a planet carrier, having a planetary gear journal which supports a first toothing segment and a second toothing segment and has a first bearing section and a second bearing section. The first bearing section is located in an intermediate region between the first and the second toothing segment, the second bearing section adjoins the first toothing segment on a side facing away from the second toothing segment, in the region of the first bearing section a first rolling bearing is arranged which is designed as a cylindrical roller bearing, the cylindrical rollers of which roll on a running surface provided by the planetary gear journal, and the first rolling bearing has an outer ring which is seated in a first side part of a planet carrier.

### BACKGROUND

The invention relates to a bearing arrangement for a stepped planetary gear, as well as an epicyclic gearing arrangement equipped with such a bearing arrangement for a motor vehicle drive unit.

### SUMMARY

A bearing arrangement for a stepped planetary gear, which is characterized in an advantageous mechanical operating behavior and particularly can be used in an epicyclic gearing arrangement for a motor vehicle drive unit.

The bearing arrangement for supporting a stepped planetary gear in a planet carrier comprises:
a planetary gear journal comprising a first toothing segment and a second toothing segment and a first bearing section and a second bearing segment, with
the first bearing section being located in an intermediate area between the first and the second toothing sections,
the second bearing section following on a side of the first toothing section facing away from the second toothing section,
a first roller bearing being arranged in the area of the first bearing section, which is embodied as a cylindrical roller bearing, with its cylindrical rollers rolling on a running surface provided by the planetary gear journal, and
the first roller bearing comprising an outer ring which rests in a first side part of a planet carrier.

This allows advantageously, while requiring little structural space, a mechanically advantageous support of a stepped planetary gear in a planet carrier, with the cylindrical roller bearing transmitting the overwhelming part of the forces engaging at the stepped planetary gear into the planet carrier, and via the second bearing section then the axial position of the stepped planet can be determined.

Preferably the internal diameter of the first outer ring of the first roller bearing is sized bigger than the outside diameter of the first toothing section. This way it is advantageously possible to fix the first outer ring in advance in the planet carrier and then to push this first toothing section through this outer ring and also to arrange the cylindrical rollers in advance between the two toothing sections.

The bearing provided in the proximity of the second bearing section is advantageously also embodied as a roller bearing, with it now preferably comprising both an outer bearing ring as well as an inner bearing ring resting on the journal. This second roller bearing acts, as already stated above, as a fixed bearing and can for this purpose be designed in particular as a grooved ball bearing.

The second toothing section is preferably provided by a separately generated spur gear, which preferably rests via an axial gearing in a rotationally fixed fashion on the planetary gear journal and here in turn is fixed with a press fit.

An epicyclic gearing arrangement for a motor vehicle drive unit is also provided, with:
a first sun gear,
a second sun gear,
a epicyclic housing acting as the planet carrier,
a planet arrangement accommodated in the planet carrier, comprising a first and a second planet, which engage the two sun gears such that the two sun gears are coupled with each other in a manner rotational in opposite directions;
a stepped planetary gear comprising a first toothing section and a second toothing section and being supported on the planet carrier,
a ring gear framing the planet carrier in a manner concentric in reference to its axis of revolution and engaging the first toothing section of the stepped planet, and
a third sun gear engaging the second toothing section of the stepped planetary gear and arranged at the same axis as the axis of revolution of the planet carrier,
with
the stepped planetary gear resting in the planet carrier via a bearing arrangement of the above-mentioned type,
the first toothing section of the stepped planetary gear extending in the axial plane of the first and the second sun gear, and
the stepped planetary gear being overhung at the planet carrier such that the second toothing section extends on the exterior of the planet carrier facing away from the first toothing section.

This way it is advantageously possible to create an epicyclic gearing arrangement in which the planet carrier provided to realize the differential transmission function acts simultaneously as the planet carrier for a stepped planetary gear driving the planet carrier, allowing the forces engaging the stepped planetary gear to be transmitted via the bearing arrangement according to the invention advantageously into the planet carrier. This leads to an advantageous stress of the planet carrier with regards to the mechanic structure and also allows the option to use any structural space remaining between the planets relevant for the differential function in the planet carrier for the stepped planet or planets. Additionally, an advantageous design of the drive torque develops in the planet carrier such that it can be supported via cost-effective bearing sites on the shaft systems provided for power transmission.

The second toothing section of the stepped planetary gear projects preferably axially beyond a face of the side part of the planet carrier and is preferably supported at the planet carrier by two bearings, accommodating the first toothing section between each other.

According to a particularly preferred embodiment of the invention the epicyclic gearing is embodied such that the two sun gears, the planetary arrangement, and the planet carrier form a spur gear differential for the symmetric branching of the drive power guided via the planet carriers to the two sun gears. The two sun gears can be arranged by special outside dimensioning and complementary design of the planet arrangement laying in close proximity to each other such that the axial length of the first toothing section of the stepped planetary gear is equivalent to the sum of the widths of the crown gears of the two inner sun gears.

The planet carrier is preferably produced as a formed sheet metal part and comprises here a first side part and as second side part, with the two inner sun gears being located axially between these two side parts. The stepped planetary gear can then be integrated in the transmission system such that it axially penetrates the first side part radially distanced from the circumferential axis and is parallel thereto such that then the second toothing section of the stepped planetary gear extends on a side facing away from the first toothing section of the first side part outside the planet carrier. For this second toothing section then a so-called overhung position results, with this overhung position, due to the support of both sides of the first toothing section exhibiting high rigidity in the planet carrier.

The stepped planet is preferably designed such that the first toothing section extending in the axial plane of the inner sun gears exhibits a pitch diameter which is smaller than the pitch diameter of the second toothing section. This way it is possible to keep the diameter of the third sun gear, engaging the second toothing section and driving it, with relatively small dimensions and realize via two gear engagements a high overall transmission ratio. In a particularly advantageous fashion by the concept according to the invention a reduction of the relative motion of the parts develops, since numerous adjacent parts or those positioning each other via bearing sites or motion areas have the same circumferential directions. For example, the third sun gear provided for driving the stepped planetary gear has the same direction of rotation as the output shaft driven by the first inner sun gear. The planet carrier and the two inner sun gears also have the same direction of rotation so that here relative motions develop only within the scope of the compensating effect of the differential transmission system at low relative angular velocities.

In the transmission system according to the invention it is possible in an advantageous fashion that the third sun gear and the first driven shaft coupled to the first sun gear rest on each other in a manner rotational via a sun gear bearing point. This support can be provided particularly by a needle bearing or a cylindrical roller bearing, with the running surfaces of the roller bodies advantageously being provided directly by appropriate circumferential areas of each third sun gear (cylindrical inner area) and the first driven shaft (cylindrical outer surface).

The support of the planet carrier can advantageously be provided in the first side part of the planet carrier and the drive shaft coupled to the first sun gear being supported on each other in a rotational fashion via a first planet carrier bearing point. This bearing point can advantageously be realized as a friction bearing, since in this friction bearing only the relative motions need to be permitted which develop within the scope of the compensating effect of the differential transmission system. In the same fashion, then the second side part of the planet carrier and a second driven shaft coupled to the second sun gear can be supported on each other in a rotational fashion via a second planet carrier bearing point, with this bearing point in turn preferably being realized as a friction bearing.

The stepped planetary gear preferably forms a part of a stepped planetary group, with the stepped planetary gears of each step planetary group preferably being provided with identical designs and connected to the planet carrier in the same circumferential pitch. This stepped planetary group comprises then preferably at least two, particularly three or even four stepped planetary gears arranged on the planet carrier in identical pitch. The stepped planetary gears can also be designed as skew gear-stepped planetary gears. The gearing angle may here be selected in turn such that an at least largely compensating effect of the axial force component of the reaction forces engaging the stepped planetary gears develops. The fixation of the stepped planetary gear is preferably accomplished via the second bearing point, by which it is supported on the side, facing away from the second toothing section, in the second side part of the planet carrier in a rotary fashion.

The stepped planetary gear can advantageously be produced as a structure designed such that particularly the first toothing section forms a part of a mandrel, which is inserted via a toothing into a spur gear forming the second toothing section. The above-mentioned bearing arrangement supporting the stepped planetary gear in the second, i.e. the “rear” planet carrier-side part, can be designed such that it allows a passing of the first toothing section through the respective bore in the second planet carrier-side part. For this purpose, then the outside diameter of the first toothing section is sized smaller than the inner bore of a bearing seat accommodating a roller bearing in the second planet carrier-side part.

However it is also possible, in particular, to design the stepped planetary gear such that in the inner area of the first toothing section an entrainer profile is formed, particularly a spline allowing a complementarily designed pin to engage it.

The drive of the third sun gear occurs preferably by an electromechanical drive unit. This may show a hollow shaft runner, by which a driven shaft extends axially through the drive arrangement. The electromechanical drive unit comprises then a motor arranged coaxially in reference to said driven shaft. However, it is also possible to drive the third sun gear by another connection of a drive unit. For example, the drive of the third sun gear can occur via a spur gear, a tension drive, or also a miter gear. As an alternative to a purely electric drive of the third sun gear it is also possible to drive it by a different drive system, e.g., an internal combustion engine or a hybrid drive system.

The drive unit according to the invention may advantageously be used also for implementing a rear axle system, which is compatible e.g. to the connection sites of a conventional rear axle such that the drive unit according to the invention can be integrated in vehicles with their base plate primarily being designed for other drive types.

### BRIEF DESCRIPTION OF THE DRAWINGS

Additional details and features of the invention are discernible from the following description in connection with the drawings. Shown are:

FIG. 1 a schematic illustration to show the design of an epicyclic gearing arrangement realized with the use of a bearing arrangement according to the invention, which particularly can be used as a component of an electromechanical rear axle drive;

FIG. 2 a simplified axial cross-section to explain further details of the bearing system supporting the stepped planetary gear on the planet carrier.

### DETAILED DESCRIPTION

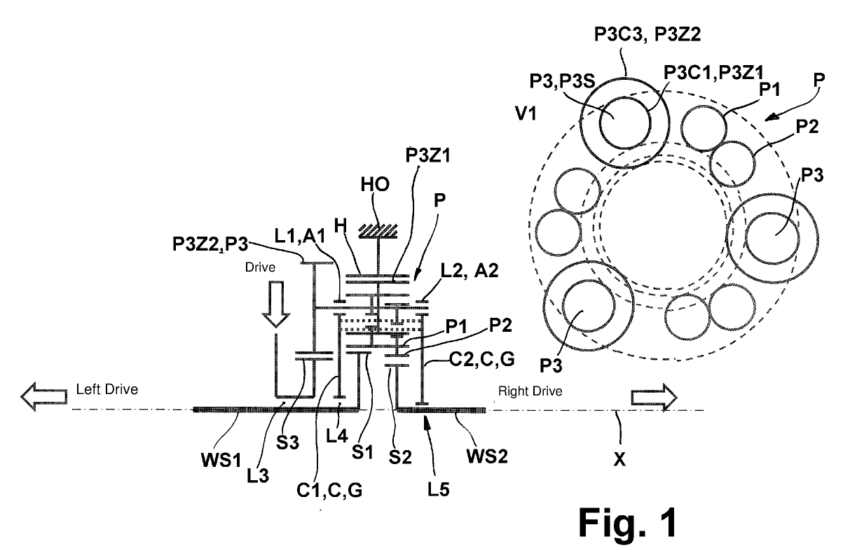

The illustration according to FIG. 1 shows an epicyclic gearing according to the invention for a motor vehicle drive system, comprising a first sun gear S1, a second sun gear S2, an epicyclic housing G acting as the planet carrier C, a planet arrangement P with a first and a second planet P1, P2, which engage each other and are connected to the two sun gears S1, S2 such that the two sun gears S1, S2 are coupled to each other in a rotational fashion via the planets P1, P2.

The epicyclic gearing comprises further a stepped planetary gear P3, which is formed by a planetary gear journal P3S and a spur gear P3S1, and comprises a first toothing section P3Z1 and a second toothing section P3Z2. Furthermore the epicyclic gearing comprises a ring gear H, which engages the first toothing section P3Z1 of the stepped planetary gear P3. The drive of the stepped planetary gear P3 is provided via a third sun gear S3, which engages the second toothing section P3Z2 of the stepped planetary gear P3 and is arranged on the same axis as the circumferential axis X of the epicyclic housing G. The first toothing section P3Z1 of the stepped planetary gear P3 extends in the axial plane of the first and the second sun gear S1, S2.

The planetary gear journal P3S further comprises a first bearing section A1 and a second bearing section A2. The planetary gear journal P3S is supported on the planet carrier C such that the first bearing section A1 is located in an intermediate section between the first and the second toothing sections P3Z1, P3Z2, and additionally the second bearing section A2 adjoins the first toothing section P3Z1 at the side facing way from the second toothing section P3Z2.

A first roller bearing L1 is arranged in the area of the bearing section A1, which is embodied as a cylindrical roller bearing, with its cylindrical rollers LW1 rolling on the running surface directly provided by the planetary gear journal P3S. The first roller bearing L1 comprises an outer ring L1Ra, which rests in a first side part C1 of the planet carrier C.

The inner diameter of the first outer ring L1Ra of the first roller bearing L1 is greater than the outer diameter of the first toothing section P3Z1. Additionally, the outside diameter of the first toothing section P3Z1 is smaller than the outside diameter of the second toothing section P3Z2.

A second roller bearing L2 is provided in the proximity of the second bearing section A2, which comprises an inner bearing ring L2i, second roller bodies LW2, and an outer bearing ring L2a. The second roller bearing L2 represents a fixed bearing and is formed as a grooved roller bearing. The second toothing section P3Z2 is provided by a spur gear P3S1, which is placed on the planetary gear journal P3S in a rotationally fixed fashion. A lateral guidance of the cylinder rollers L1W of the first roller bearing L1 is provided by the spur gear P3S. For this purpose, an annular shoulder is formed at the spur gear P3S, which projects less than the radial level of the cage L1K to the cylinder rollers L1W. An annular shoulder is also formed at the side of the first toothing section P3Z1, which also projects over part of the cylindrical rollers L1W.

The stepped planetary gear P3 is supported at two locations via the bearing arrangement according to the invention using a first and a second bearing point L1, L2 in the planet carrier P. The two sun gears S1, S2, the planet arrangement P, and the epicyclic housing G form the spur gear differential for the symmetric branching of the drive power guided via the planet carrier C to the two sun gears S1, S2.

The planet carrier C comprises a first side part C1 and a second side part C2 and the two sun gears S1, S2 are arranged axially between these two side parts C1, C2.

The stepped planetary gear P3 penetrates the first side part C1 axially and the second toothing section P3Z2 of the stepped planetary gear P3 extends on the side of the first side part C1 facing away from the first toothing section P3Z1. The first toothing section P3Z1 comprises here a pitch diameter which is smaller than the pitch diameter of the second toothing section P3Z2. The second toothing section P3Z2 overhangs the planet carrier C using the bearing arrangement according to the invention, i.e. its end section, facing away from the planet carrier C, is not supported via any additional bearing device.

The power draw from the two inner sun gears S1, S2 is accomplished via a first and a second driven shaft WS1, WS2. The third sun gear S3 provided for driving the second toothing section P3Z2 of the stepped planetary gear is supported on the first driven shaft WS1 coupled to the first sun gear S1 via a sun gear-bearing point L3 in a rotary fashion. Both components rotate within the scope of operation in the same circumferential directions such that here a reduction of the relative motion results.

The first side part C1 of the planet carrier C and the driven shaft WS1 coupled to the first sun gear S1 are supported in a rotary fashion in reference to each other via a first planet carrier-bearing point L4. The second side part C2 of the planet carrier C and the driven shaft WS2 coupled to the second sun gear S2 are supported in a manner rotational in reference to each other via a second planet carrier-bearing point L5.

The first toothing section P3Z1 of the stepped planetary gear P3 engages the ring gear H radially from the inside. The ring gear H is anchored in a stationary fashion in the transmission housing HO.

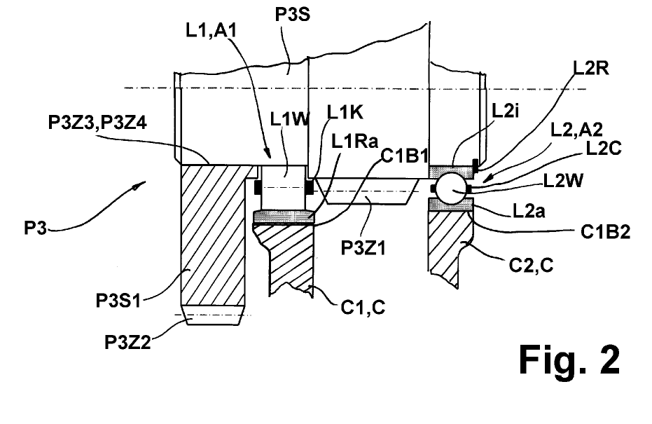

As discernible from the inserted sketch VI in FIG. 1, the stepped planetary gear P3 forms a part of a stepped planetary group, with the stepped planetary gears P3 of each stepped planetary group being embodied with identical designs and being connected to the planet carrier C in the same circular pitch. As mentioned above, the stepped planetary gear P3 is produced as an assembled structure, i.e. it is comprised of several parts. As explained in greater detail in the following in connection with FIG. 2 the stepped planetary gear P3 can particularly be designed such that the first toothing section P3Z1 forms a part of a journal P3S, which is inserted via a gearing into a spur gear P3S2 forming the second toothing section.

The circular pitch P3C3 of the second toothing section P3Z2 shown in sketch V1 has a greater diameter than the circular pitch P3C1 of the first toothing section P3Z1. The first toothing section P3Z1 extends inside the planet carrier C between the side parts C1, C2 thereof.

The planetary arrangement P is formed in the exemplary embodiment shown such that the first and second planets P1, P2 engage each other in the axial plane of the second sun gear S2. The first planet P1 is here designed as a “long” planet, which extends over the entire length of the external teeth of the first sun gear S1 and the external teeth of the second sun gear S2. The second planet P2 is embodied as a “short” planet and extends only over the external teeth of the second sun gear S2 and engages it. In order to prevent the first planet P1 from engaging the second sun gear S2, the sun gears S1, S2 are designed such that with identical teeth count the root circle diameter of the first sun gear S1 is greater than the outside diameter of the second sun gear S2. This measure allows the arrangement of the first planet P1 of the planetary arrangement P on a circular pitch such that its diameter is greater than the circular pitch on which the second planet P2 of the planet arrangement P is placed, and the first planets P1 are thus released from the outer teeth of the second sun gear S2.

In the exemplary embodiment shown here three identically designed stepped planetary gears P3 are supported via the bearing arrangement according to the invention at the planet carrier C. The planet arrangement P provided to realize the differential transmission function is respectively provided in an intermediate area following the stepped planetary gears P3. When using three stepped planetary gears P3, accordingly three planet arrangements P are also provided, which respectively have a first and a second coupling planet P1, P2. By the close proximity of the stepped planetary gears P3 and the coupling planets P1, P2 of the planet arrangement P here a beneficial force transmission develops inside the side parts C1, C2 of the planet carrier C as well as the realization of the transmission effect and the differential function on a very small structural space.

The illustration according to FIG. 2 shows in the form of a simplified, axially cross-sectional detail the design of the bearing arrangement according to the invention for supporting a stepped planetary gear P3 in the side parts C1, C2 of the planet carrier C. The stepped planetary gear P3 comprises a core journal P3S, which on the one hand forms the first toothing section P3Z1 and on the other hand shows an insertion section P3Z3, which can be inserted in a rotationally fixed fashion into a complementary bore P3Z4 of the spur gear P3S1 provided with internal toothing, particularly can be pressed therein. The spur gear P3S1 forms at its outer perimeter the second toothing section P3Z2 of the stepped planetary gear P3.

The support of the stepped planetary gear P3 in the planet carrier C is accomplished, as shown, by a first roller bearing L1 in the first side part C1 and by a second roller bearing L2 in the second side part. The first roller bearing L1 is located here axially between the first and the second toothing section P3Z1, P3Z2 of the stepped planetary gear. This first roller bearing L1 is designed as a floating bearing and is additionally embodied as a cylindrical roller bearing. The roller bodies L1W of this first bearing L1 of the stepped planetary gear run directly on a cylindrical outer perimeter area of the core journal P3S. The first bearing L1 comprises further an outer bearing ring L1Ra, which is pressed into a matching receiving bore C1B1. The roller bodies L1W are guided in a cage L1K. The outer bearing ring L1R1 is axially secured by a safety device, not shown here in greater detail, (e.g., by beads) in the receiving bore C1B1. The side part C1 of the planet carrier C is illustrated thickened in the section framing the receiving bore C1B1. The respective bead is produced by way of plastic deformation of the original material used to form the side part C1. The material accumulation is generated by a radial shifting of the material initially located in the proximity of the receiving bore C1B1 towards the outside.

On the side of the core journal P3S facing away from the second toothing section P3Z2 the core journal rests via the second bearing L2 in the second side part C2 of the planet carrier C. This second bearing L2 forms the fixed bearing and defines the axial position of the core journal P3S in the planet carrier C. This fixed bearing L2 is here formed as a grooved ball bearing. It comprises an inner bearing ring L2i and an outer bearing ring L2a, as well as roller bodies L2W formed as balls, which are guided in a cage L2C. The inner bearing ring L2i is secured by a safety ring L2R on the core journal P3S. The outer bearing ring L2a of the second bearing L2 is pressed, similar to the outer bearing ring L1Ra of the first bearing L1, into a bore C1B2 which is formed in an area of the second side part C2 framed by a bead. The axial securing of this outer bearing ring L2a can in turn be accomplished by a plastic deformation of the material of the second side part C2 framing the outer bearing ring in the proximity of its facial areas.

In the exemplary embodiment shown the first bearing point L1 is designed such that the inner diameter of the first outer bearing ring L1Ra is greater than the outside diameter of the first tooting section. This allows firstly to fix the first outer bearing ring L1Ra in the first side part and then to add the core journal P3S through the first outer bearing ring L1Ra. The second bearing L2 can also be fixed prior to inserting the core journal P3S initially in the second side part C2, with then after the insertion of the respective end section of the core journal P3S it is axially fixed in the second bearing by inserting the safety ring L2R.

The spur gear P3S1 forming the second toothing section P3Z2 of the stepped planetary gear P3 rests on the side of the planet carrier C facing away from the second side part C2 of the planet carrier C and is overhung via the two bearings L1, L2. The second toothing section P3Z2 is therefore located outside the planet carrier C and rests on a journal P3S of the stepped planetary gear P3, ultimately in an overhung fashion.

1. A bearing arrangement for supporting a stepped planetary gear in a planetary gear carrier, comprising:
a planetary gear journal comprising a first toothing segment and a second toothing segment and a first bearing section and a second bearing section,
the first bearing section is located in an intermediate area between the first and the second toothing sections;
the second bearing section extends from a side of the first toothing section facing away from the second toothing section; and
a first roller bearing provided as a cylindrical roller bearing, being arranged in an area of the first bearing section, the cylindrical roller bearing including cylindrical rollers that roll on a running surface of the planetary gear journal, and a first outer ring which rests in a first side part of a planet carrier.

2. The bearing arrangement according to claim 1, wherein an inner diameter of the first outer ring of the first roller bearing is greater than a head circle diameter of the first toothing section.

3. The bearing arrangement according to claim 1, wherein an outside diameter of the first toothing section is smaller than an outside diameter of the second toothing section.

4. The bearing arrangement according to claim 1, further comprising a second roller bearing provided in an area of the second bearing section, the second roller bearing comprising an inner bearing ring, second bearing rollers, and an outer bearing ring.

5. The bearing arrangement according to claim 4, wherein the second roller bearing is a fixed bearing.

6. The bearing arrangement according to claim 5, wherein the second roller bearing is a grooved ball bearing.

7. The bearing arrangement according to claim 1, wherein the second toothing section is provided by a spur gear that is rotationally fixed to the planetary gear journal.

8. The bearing arrangement according to claim 7, wherein a lateral guidance of the cylinder rollers of the first roller bearing is established by the spur gear.

9. The bearing arrangement according to claim 7, wherein a lateral guidance of the cylinder rollers of the first roller bearing is established via an annular shoulder adjacent to the first toothing section.

10. An epicyclic gearing arrangement for a motor vehicle drive unit, comprising:
a first sun gear;
a second sun gear;
a planet carrier;
a planet arrangement, comprising a first planet and a second planet which engage the first and second sun gears such that the
first and second sun gears are coupled with each other in a manner rotational in opposite directions;
a stepped planetary gear comprising a first toothing section and a second toothing section;
a ring gear engaging the first toothing section of the stepped planetary gear; and
a third sun gear engaging the second toothing section of the stepped planetary gear and arranged on a same axis as an axis of revolution
of the planet carrier, the first toothing section of the stepped planetary gear extending in an axial plane of the first sun gear and the second sun gear, and being supported at the planet carrier via the bearing arrangement according to claim 1.

11. The epicyclic gearing arrangement according to claim 10, wherein an inner diameter of the first outer ring of the first roller bearing is greater than a head circle diameter of the first toothing section.

12. The epicyclic gearing arrangement according to claim 10, wherein an outside diameter of the first toothing section is smaller than an outside diameter of the second toothing section.

13. The epicyclic gearing arrangement according to claim 10, further comprising a second roller bearing provided in an area of the second bearing section, the second roller bearing comprising an inner bearing ring, second bearing rollers, and an outer bearing ring.

14. The epicyclic gearing arrangement according to claim 10, wherein the second toothing section is provided by a spur gear that is rotationally fixed to the planetary gear journal.

15. The epicyclic gearing arrangement according to claim 14, wherein a lateral guidance of the cylinder rollers of the first roller bearing is established by the spur gear.

16. The epicyclic gearing arrangement according to claim 14, wherein a lateral guidance of the cylinder rollers of the first roller bearing is established via an annular shoulder adjacent to the first toothing section.

17. An epicyclic gearing arrangement for a motor vehicle drive unit, comprising:
a first sun gear;
a second sun gear;
a planet carrier;
a planet arrangement, comprising a first planet and a second planet which engage the first and second sun gears, respectively, and engage each other such that the first and second sun gears are coupled with each other;
a stepped planetary gear comprising a first toothing section and a second toothing section;
a ring gear engaging the first toothing section of the stepped planetary gear;
a third gear engaging the second toothing section of the stepped planetary gear;
a bearing arrangement that supports the stepped planetary gear in the planetary gear carrier, comprising:
a planetary gear journal on which the first toothing segment and the second toothing segment are located, having a first bearing section and a second bearing section, the first bearing section is located in an intermediate area between the first and the second toothing sections, and the second bearing section extends from a side of the first toothing section facing away from the second toothing section; and
a first roller bearing provided as a cylindrical roller bearing arranged in an area of the first bearing section, the cylindrical roller bearing including cylindrical rollers that roll on a running surface of the planetary gear journal, and a first outer ring which rests in a first side part of the planet carrier.

18. The epicyclic gearing arrangement according to claim 17, wherein an inner diameter of the first outer ring of the first roller bearing is greater than a head circle diameter of the first toothing section.

19. The epicyclic gearing arrangement according to claim 17, wherein a lateral guidance of the cylinder rollers of the first roller bearing is established by the spur gear.

20. The epicyclic gearing arrangement according to claim 17, wherein a lateral guidance of the cylinder rollers of the first roller bearing is established via an annular shoulder adjacent to the first toothing section.
